(19) United States
(12) Patent Application Publication
(10) Pub. No.: US 2004/0218632 A1
(43) Pub. Date: Nov. 4, 2004

(54) Method and apparatus of maximizing packet throughput

(76) Inventor: Ki Bong Kang, Santa Clara, CA (US)

Correspondence Address: HAVERSTOCK & OWENS LLP, 162 NORTH WOLFE ROAD, SUNNYVALE, CA, 94086, US

(21) Appl. No.: 10/783,281

(22) Filed: Feb. 20, 2004

Related U.S. Application Data
(60) Provisional application No. 60/449,332, filed on Feb. 21, 2003.

(51) Int. Cl. H04J 3/00

(52) U.S. Cl. 370/474; 370/338; 370/401

(57) ABSTRACT

In accordance with an embodiment of the present invention, a method and apparatus for maximizing packet throughput on a network is disclosed. The apparatus comprises means for computing an average packet size for incoming packets. The average packet size can be dynamically changed. The apparatus also comprises means for adjusting an amount of data to be transmitted per unit of time based on the average packet size. The amount of data to be transmitted per unit of time can also be dynamically adjusted. The amount of data to be transmitted per unit of time can be based on both a processing speed of an access point and the average packet size.

### RELATED APPLICATION

This patent application claims priority under 35 U.S.C. 119 (e) of the co-pending U.S. Provisional Patent Application Ser. No. 60/449,332, filed Feb. 21, 2003, and entitled “WIRELESS LAN ACCESS POINT (AP) THROUGHPUT MAXIMIZATION MECHANISM”. The Provisional Patent Application Ser. No. 60/449,332, filed Feb. 21, 2003, and entitled “WIRELESS LAN ACCESS POINT (AP) THROUGHPUT MAXIMIZATION MECHANISM” is also hereby incorporated by reference.

### FIELD OF THE INVENTION

The present invention relates to network technology. More particularly, the present invention relates to a method and apparatus of maximizing packet throughput in a wireless LAN network environment by dynamically adjusting an amount of data to be transmitted per unit of time based on average packet size.

### BACKGROUND OF THE INVENTION

A fundamental role of a network is routing packets of data from one device or host to another. Packets are transferred using switches, routers, hubs, bridges and the like which are coupled by communications links. Originally, the communication links were wires including coaxial cable, twisted pair, fiber optics cables among others. More recently, wireless communication links are available. To promote compatibility and more universal wireless access, many commercial devices operate according to standards promulgated by the IEEE including, but not limited to 802.11a, 802.11b and more recently 802.11g.

To ensure that the data is accurately transferred, certain overhead operations are undertaken to add assurance information to the packets. Thus, packets contain a header, which includes information such as the address of the source and destination of the packet and its size, and the payload, comprising the data to be delivered to the recipient. The packet header includes the address which uniquely identifies the source and the destination devices. It is desirable that data is transferred as rapidly as possible.

In a wireless environment, at least one access point is used for receiving packets from a wired network and downloading packets to a wireless device, such as a wireless computer, e-mail device, wireless printer or PDA. Other wireless data devices are also possible. The access point can also upload packets transmitted from the wireless device to the network. Generally, the access point is coupled to the network via a switch. While a switch is typical, the access point can be coupled to other types of network appliances, which will be referred to hereafter as a switch.

The speed with which packets (or data) can be transmitted from one device to another is called its bit rate. The bit rate is the number of bits that pass through a given point in a telecommunication network in a given amount of time. A typical switch has a bit rate of 100 Mbps (mega bits per second). A typical 802.11b access point has a bit rate of 11 Mbps. A typical 802.11a access point has a bit rate of 54 Mbps.

FIG. 1 shows a block diagram of a prior art wireless network comprising a router coupled to an access point. A network 30 is coupled to a switch 10. The network 30 can be a local area network or the Internet or a combination thereof. The switch 10 can be any commercially available networking device. A representative switch can operate to transmit data at 100 Mbps to the network 30. The switch 10 is coupled in turn to a wireless access point 20. A typical switch 10 can also transmit data to the access point 20 at data rates up to 100 Mbps. The access point 20 is configured to communicate wirelessly with one or more wireless devices 40. The wireless device can be any digital device configured with an appropriate wireless transceiver.

A representative access point 20 operates at a lower bit rate than the switch 10, e.g. 11 Mbps or 54 Mbps. Further, the actual throughput for data (sometimes referred to as the payload) of the access point is even lower because each packet includes overhead. The overhead includes the LAN header and tail. In addition, for wireless transmission the access point 20 adds a wireless header to the packet and also includes certain wireless control packets when needed. This overhead is included in the packet, at least in part, to ensure that the transmission of the packet is accurate. Thus, the access point 20 is actually processing data input from the switch 10 to a wireless device 40 in the range of 5 to 6 Mbps for an access point 20 which is capable of transmitting and receiving data at 11 Mbps. Thus, the actual speed of data transmission is a function of the bit transfer rate, the number of bytes in the packets in the stream and further reduced by retransmissions, if any, required to successfully transmit packets of data. While the network provides for bit transmissions in both directions, because the switch 10 is much faster than the access point 20, the bottle neck occurs in transmission from the switch 10 to the access point 20 and not in the other direction.

If the number of bytes in each packet is at the maximum allowed under the transmission standard, then the speed of data transmission will increase because more data is transferred per packet and per header. Likewise, if the number of bytes in the packet is smaller, then the speed of data transmission will decrease because the data transferred in each packet and with each header is less. There is a theoretical maximum speed (TMS) for data transmission that is a function of the bit transfer rate of the access point 20, the number of bytes of data in the packet and the number of bytes in the header.

FIG. 2 shows a graph of speed of data transmitted from the access point 20 to the wireless device 40 (FIG. 1). As the speed of the data transfer from the switch 10 to the access point 20 increases from zero bps to the TMS, the speed of data transfer from the access point 20 to the wireless device 40 likewise increases from zero bps to the TMS. In general, the relationship between these two data speeds is linear below the TMS and increase approximately equally. Surprisingly, as the data transfer rate from the switch 10 to the access point 20 increases above the TMS, the transfer rate to the wireless device 40 drops. The TMS for small packet sizes TMS1 is lower than for large packet sizes TMS2. In certain cases, a 40% degradation in transfer rate is seen. FIG. 2 also shows that the degradation is more severe when the packet size is smaller than for large packet sizes.

FIG. 3A schematically represents the overhead burden for small packets. In particular, the data portion of the packet is shown in white and the overhead is shown in black. Likewise, FIG. 3B schematically represents the overhead burden for large packets. The drawings graphically show that the percentage of overhead for small packets is substantially larger than for large packets.

It is theorized that the degradation occurs when the access point 20 becomes overburdened so that the rate of transfer from the switch 10 exceeds the rate of transfer for the access point 20. As the access point 20 is required to calculate the wireless header, the calculation burden on the access point 20 is substantially more significant for small packets than for large packets. Also, the ratio data bits to overhead bits decreases for smaller packets. These factors contribute to the greater performance degradation for small packet sizes. When that occurs, it is believed that the access point 20 is unable to properly process all the packets it receives from the switch 10. When that occurs some packets are dropped As is well known, packet transfers are concluded by the receiving device sending a handshake signal acknowledging proper receipt of the packet. When packets are dropped or corrupted, no handshake signal is sent. After a predetermined period of time, the switch 10 or the network 30 or both will resend the failed packet or packets thereby causing a performance degradation.

What is needed is a traffic control method and apparatus for maximizing packet throughput in a network environment. A system is needed which avoids degradation of system performance caused by overloading a slowest element. What is also needed is a traffic control method and apparatus which dynamically adjusts an amount of data to be transmitted per unit of time based on an average packet size during the most recent period.

### SUMMARY OF THE INVENTION

The present invention overcomes network congestion problems in a wireless network whenever an input bit rate (e.g. the bit rate of the switch) is greater than an output bit rate (e.g. the bit rate of the access point). The present invention uses a switch, which performs a traffic control function. Further, the switch operates to control the input bit rate by regulating the amount of data to be transmitted on a network. Preferably, the traffic control function is dynamic in that it modulates the bit rate in response to the average packet size at the time.

In accordance with an embodiment of the present invention, a method of maximizing packet throughput on a network computes an average packet size and then adjusts an amount of data to be transmitted per unit of time based on the average packet size. The amount of data to be transmitted per unit of time can be dynamically adjusted in response to changes in the average packet size.

A switch in the present invention preferably adjusts the amount of data to be transmitted. The switch can be implemented in a network gateway server. The data can be transmitted to a wireless device via an access point. The amount of data to be transmitted per unit of time can be based on a processing speed of an access point. Further, the amount of data to be transmitted per unit of time can be based on both the processing speed of the access point and the average packet size. The processing speed of the access point is preferably predetermined.

In accordance with an alternative embodiment of the present invention, an apparatus for maximizing packet throughput on a network is disclosed. The apparatus comprises means for computing an average packet size; and means for adjusting an amount of data to be transmitted per unit of time based on the average packet size.

In accordance with another embodiment of the present invention, a method of maximizing packet throughput on a network is disclosed. The method comprises the steps of computing an average packet size; and dynamically adjusting an amount of data to be transmitted per unit of time based on the average packet size, wherein the average packet size is dynamically changed. When an incoming packet is greater than the average packet size the average will increase. Generally, because the sample size is significant the amount of change caused by the difference in size attributable to any one packet is small. Thus, the average will change slowly. Nevertheless, as the average packet size increases, the amount of data to be transmitted from the switch to the access point per unit of time increases. Likewise, when the incoming packet is less than the average packet size the average will decrease. Thus, as the average packet size decreases, the amount of data to be transmitted from the switch to the access point per unit of time decreases.

In accordance with another embodiment of the present invention, an apparatus for maximizing packet throughput on a network is disclosed. The apparatus comprises means for computing an average packet size; and means for dynamically adjusting an amount of data to be transmitted per unit of time based on the average packet size, wherein the average packet size is dynamically changed.

### BRIEF DESCRIPTION OF THE SEVERAL VIEWS OF THE DRAWINGS

FIG. 1 is a block diagram of a prior art wireless network comprising a switch coupled to an access point for transmitting to and receiving packets of data from one or more wireless devices.

FIG. 2 is a graph illustrating performance characteristics of the prior art access point of FIG. 1.

FIGS. 3A and 3B are diagrams representing the overhead burden of small and large packets, respectively.

FIG. 4 is a schematic diagram illustrating an apparatus for maximizing packet throughput on a network in which the present invention may be implemented.

FIG. 5 is a graph illustrating performance characteristics of the access point of the present invention.

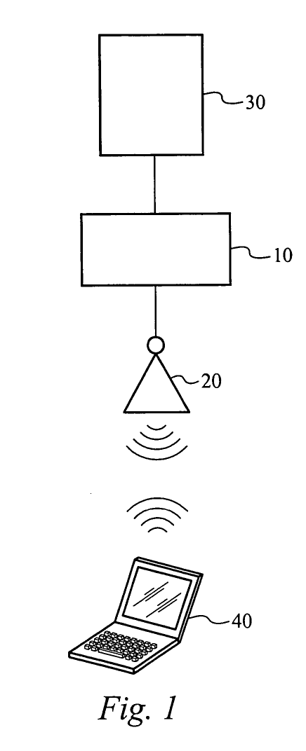

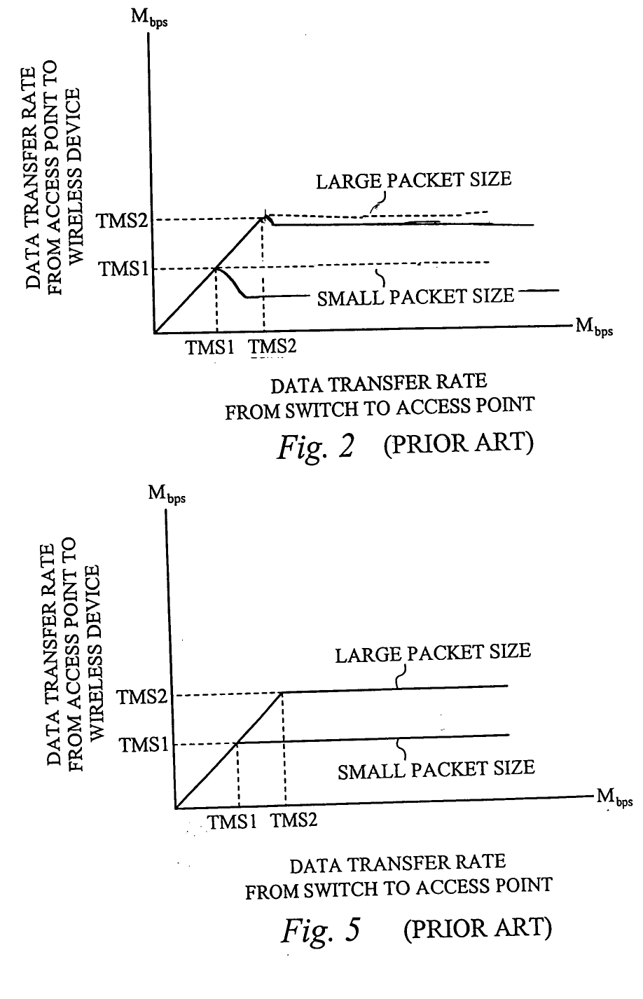

### DETAILED DESCRIPTION OF THE INVENTION

Reference will now be made in detail to the preferred and alternative embodiments of the invention, examples of which are illustrated in the accompanying drawings. While the invention will be described in conjunction with the preferred embodiments, it will be understood that it is not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it should be noted that the present invention may be practiced without these specific details or with equivalents of these details. In other instances, well known methods, procedures and components have not been described in detail as not to unnecessarily obscure aspects of the present invention. The present invention will now be described with reference to the accompanying drawings.

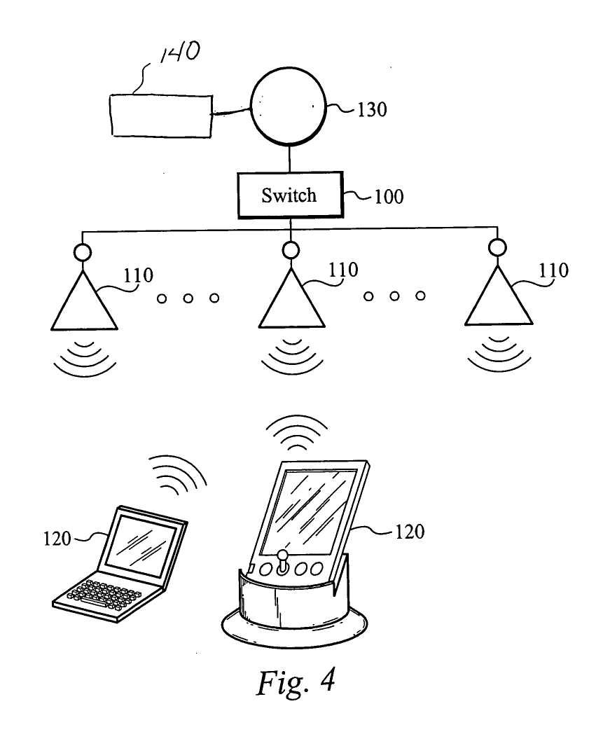

FIG. 4 shows a schematic diagram illustrating a system for maximizing packet throughput in which the present invention may be implemented. The system includes at least one switch 100 for forwarding IP packets received from a network 130 to one or more access points 110. The network 130 can be a local area network, the Internet or a combination thereof. A server 140 is coupled to the network. Packets are then sent to one or more wireless devices 120 via the access point 110. The system can include multiple switches 100 each having one or more access points 110, as shown. The wireless device 120 can be a PDA (shown), e-mail device, wireless laptop (shown), wireless printer or any other digital wireless data device. As mentioned above, the switch 100 can have a bit rate of 100 Mbps. The access point 110 typically has a substantially slower bit rate than the switch 100. For example, the access point 110 has a bit rate of 11 Mbps for an 802.11b access point and a bit rate of 54 Mbps for an 802.11a access point.

Relative to the bit rate capacity of each access point 110, the switch 100 will control the rate at which packets are sent to each access point 110. By slowing the speed of packets, the switch 100 prevents the performance of the access point 110 from degrading as a result of becoming overburdened. It will be understood that the actual instantaneous bit rate for the switch 100 to access point 110 transfer will remain unchanged. Rather, the average transfer rate will be reduced by transmitting one or more packets and then delaying transmission of a next packet or group of packets. This delay allows the access point 110 sufficient time to calculate the wireless header and transmit the packet without having to drop packets.

In addition, as discussed above relative to the prior art, the performance of each access point 110 is also a function of the packet size. To account for packet size, the preferred switch 100 also includes means for determining the packet size of each incoming packet. For example, the switch 100 can count the number of bytes in each packet as it is received. The switch also includes means for computing an average packet size. For purposes of this disclosure, the term average can mean any statistical artifact including but not limited to the average, mean, median, and RMS, among others. Hereafter, only the term average will be used to avoid obscuring the invention in extraneous details. In the preferred embodiment, the average would be a rolling average taking into account only a predetermined number of the most recent packets. When an incoming packet is greater than the average packet size, the rolling average will increase. In the preferred embodiment, the number of packets included in the rolling average is substantial. Thus, the change in the value of the average packet size will be gradual. Nevertheless, as the average packet size increases, the amount of data to be transmitted per unit of time will increase. Likewise, when an incoming packet is less than the average packet size the rolling average decreases the average will also gradually begin to decrease. As the average packet size decreases the amount of data to be transmitted per unit of time will decrease. The means for computing average packet size can include any conventional arithmetic unit.

The switch 100 will then adjust the rate that packets will be transmitted based on the average packet size. In other words, the number of packets transmitted per unit of time will change in response to the rolling average packet size. As the packet size becomes smaller, the rolling average of packet size will decrease. In that case the rate of transmitting packets will decrease. Likewise, as the packet size increases, the rolling average of packet size will increase and the rate of transmitting packets will increase. The switch preferably dynamically determines the average packet size and correspondingly dynamically adjusts the rate of packet transmission.

In the present invention, the switch 100 detects characteristics of each access point 110 which is coupled to it. The characteristics of a plurality of commercially available access points 110 can be measured, for example in a laboratory. That information can be stored in a database in the server 140. The database will include information for each measured access point 110 including the data transfer rate for that access point that maximizes performance at each of a range of average packet sizes. For example, the table can include the following data for one exemplary access point.

TABLE 1
Access Point 1

| packet size | TMS |
|---|---|
| 64 KB | 1.1 Mbps |
| 128 KB | 2.05 Mbps |
| 256 KB | 3.25 Mbps |
| 394 KB | 4.15 Mbps |
| 512 KB | 5.75 Mbps |

The data is Table 1 is exemplary only and does not represent a real world access point. It will be understood that many more entries can be included in the table to account for smaller variations in average packet size.

The server 140 includes network management software that communicates with each access point 110 through the switch 100 via a simple network management protocol (SNMP). In this embodiment, the server 140 preferably uses this communication to detect which vendor manufactured each access point 110 is coupled to the switch 100. The network management software includes a database that profiles the measured the bit rate of each access point 110 and the data rate that will maximize the bandwidth. The server 140 then downloads this information to the switch 100. Once the information is downloaded from the server 140, the switch 100 then proceeds to adjust the transfer rate from the switch 100 to the access point 110 in response to the measured average packet size and also the data in the table.

It will be appreciated that substantial effort is required to characterize each access point 110. Further, new access points continue to be introduced commercially requiring some means to characterize such new access points and including the data into the database. Thus, alternatively the switch 100 can measure the bit rate each access point 110 which is coupled to that switch 100. Preferably, the step of measuring can occur during a start-up initialization routine or when a new access point 110 is coupled to the switch 100. The result of this step of measuring will be a table of data similar to that in the network management software embodiment discussed above. Based on the characteristics of each access point 110 which is coupled to it, the switch 100 can adjust the rate which it transmits data to each access point 110 to maximize packet throughput. The switch 100 preferably is configured to communicate with access points 110 manufactured by a variety of vendors and according to a variety of bit rates.

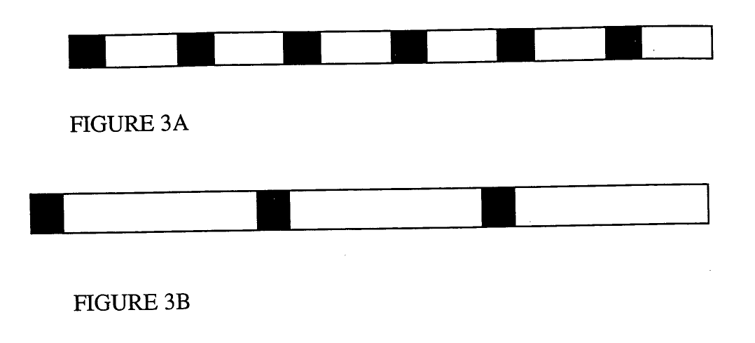

FIG. 5 is a graph illustrating performance characteristics of the access point of the present invention. As the packet transmission rate increases from zero FIG. 5 shows a graph of speed of data transmitted from the access point 110 to the wireless device 120 (FIG. 3). As the speed of the data transfer from the switch 100 to the access point 110 increases from zero bps to the TMS, the speed of data transfer from the access point 110 to the wireless device 120 likewise increases from zero bps to the TMS. In general, the relationship between these two data speeds is linear below the TMS and increase approximately equally. A system operating according to the present invention will continue to operate at the TMS because the switch 100 will control the rate of data transfer to the access point 110. Thus, there is no degradation in performance as found in the prior. Rather, the speed remains at the maximum possible level.

In summary, the apparatus for and method of maximizing packet throughput of the present invention computes an average packet size and adjusts an amount of data to be transmitted per unit of time based on the average packet size. When an incoming packet is greater than the average packet size, the average packet size will increase. When an incoming packet is less than the average packet size, the average packet size will decrease. Changes in the average will be commensurate with the number of samples in the average, but generally the change to the average will be gradual. In response to the gradual change in the average packet size, the amount of data to be transmitted per unit of time will change. As a result, the present invention recovers up to 40% of lost bandwidth by regulating the amount of data forwarded by the switch.

What is claimed is:

1. A method of maximizing a packet transfer rate in a network from a network appliance to a access point, wherein the network appliance has a faster packet transfer rate than the access point, the method comprising the steps of:
a. determining a transfer speed of packets for the access point; and
b. controlling a rate of transfer of packets from the network appliance to accommodate the access point
c. determining an average size of packets received by the network appliance for transfer to the access point; and
d. adjusting the rate of transfer of packets from the network appliance in response to the average size of packets.

2. The method according to claim 1 wherein the step of determining a transfer speed of packets for the access point comprises measuring the transfer speed.

3. The method according to claim 1 wherein the step of determining a transfer speed of packets for the access point comprises a table containing data for a plurality of commercially available access points.

4. The method according to claim 1 wherein the step of adjusting the rate of transfer is performed dynamically to accommodate changes in the average rate of transfer of packets.

5. An apparatus for maximizing a packet transfer rate in a network from a network appliance to a access point, wherein the network appliance has a faster packet transfer rate than the access point, the method comprising the steps of:
a. a system for determining a transfer speed of packets for the access point; and
b. a controller for controlling a rate of transfer of packets from the network appliance to accommodate the access point
c. a circuit for determining an average size of packets received by the network appliance for transfer to the access point; and
d. controller means for adjusting the rate of transfer of packets from the network appliance in response to the average size of packets.

6. The apparatus according to claim 5 wherein the system for determining a transfer speed of packets for the access point comprises a circuit measuring the transfer speed.

7. The apparatus according to claim 5 wherein the system of determining a transfer speed of packets for the access point comprises a table containing data for a plurality of commercially available access points.

8. The apparatus according to claim 5 wherein the controller means operates dynamically to accommodate changes in the average rate of transfer of packets.

9. A method of maximizing packet throughput on a network, comprising:
a. computing an average packet size; and
b. adjusting an amount of data to be transmitted per unit of time based on the average packet size.

10. The method of claim 9 wherein the amount of data to be transmitted per unit of time is dynamically adjusted.

11. The method of claim 9 wherein the data is transmitted to a wireless device selected form the group consisting of a PDA, wireless e-mail device, a wireless laptop, a wireless printer via an access point.

12. The method of claim 9 wherein the amount of data to be transmitted per unit of time is based on a processing speed of an access point.

13. An apparatus for maximizing packet throughput on a network, comprising:
a. means for computing an average packet size; and
b. means for adjusting an amount of data to be transmitted per unit of time based on the average packet size.

14. The apparatus of claim 13 wherein the amount of data to be transmitted per unit of time is dynamically adjusted.

15. The apparatus of claim 13 wherein the amount of data to be transmitted per unit of time is based on a processing speed of an access point.

16. A method of maximizing packet throughput on a network, comprising:
a. computing an average packet size; and
b. dynamically adjusting an amount of data to be transmitted per unit of time based on the average packet size, wherein the average packet size is dynamically changed, such that when an incoming packet is greater than the average packet size the amount of data to be transmitted per unit of time increases, and when the incoming packet is less than the average packet size the amount of data to be transmitted per unit of time decreases.

17. The method of claim 16 wherein a switch adjusts the amount of data to be transmitted per unit of time.

18. The method of claim 16 wherein the amount of data to be transmitted per unit of time is based on a processing speed of an access point.

19. The method of claim 18 wherein the amount of data to be transmitted per unit of time is based on the processing speed of the access point and the average packet size.

20. The method of claim 19 wherein the processing speed of the access point is predetermined.

21. An apparatus for maximizing packet throughput on a network, comprising:
a. means for computing an average packet size; and
b. means for dynamically adjusting an amount of data to be transmitted per unit of time based on the average packet size, wherein the average packet size is dynamically changed, such that when an incoming packet is greater than the average packet size the amount of data to be transmitted per unit of time increases, and when the incoming packet is less than the average packet size the amount of data to be transmitted per unit of time decreases.

22. The apparatus of claim 21 wherein a switch adjusts the amount of data to be transmitted per unit of time.

23. The apparatus of claim 22 wherein the amount of data to be transmitted per unit of time is based on a processing speed of an access point.

24. The apparatus of claim 23 wherein the processing speed of the access point is predetermined.
